(19) United States
(12) Patent Application Publication
(10) Pub. No.: US 2025/0096488 A1
(43) Pub. Date: Mar. 20, 2025

(54) Fire Barrier Terminal Block

(71) Applicant: The Boeing Company, Arlington, VA (US)

(72) Inventors: Lowell Bruce Campbell, Mukilteo, WA (US); Cody Jacob Queen, Everett, WA (US)

(21) Appl. No.: 18/676,792

(22) Filed: May 29, 2024

Related U.S. Application Data
(60) Provisional application No. 63/539,229, filed on Sep. 19, 2023.

(51) Int. Cl. H01R 9/24; A62C 2/06; B64D 45/00; H01R 13/533

(52) U.S. Cl. CPC H01R 9/24; A62C 2/06; B64D 45/00; H01R 13/533; B64D 2045/009; H01R 2201/26

(57) ABSTRACT

A terminal block configured to be mounted within an opening in a fire barrier. The terminal block includes a central body sized to be positioned in the opening. A lower mount extends outward from a first side of the central body. An upper mount extends outward from a second side of the central body. Mounting surfaces are positioned on each of the lower mount and the upper mount. Electrical conductors extend between the mounting surfaces on the lower mount and the upper mount with the electrical conductors configured to enable an electrical connection between first and second sections of power feed lines.

### RELATED APPLICATIONS

This application claims priority to U.S. Provisional Patent Application Ser. No. 63/539,229 filed on Sep. 19, 2023, which is incorporated herein by reference in its entirety.

### TECHNOLOGICAL FIELD

The present application is directed to devices to fill an opening in a fire barrier of an aircraft and, more specifically, to a device that fills the opening in the fire barrier and facilitates disconnecting an engine from a wing of an aircraft.

### BACKGROUND

Various aircraft can include engines mounted to the wings. Due to regulatory requirements, aircraft engines are generally required to include a fire barrier that is capable of containing and isolating a fire from within the propulsion components of the engine (e.g., the gas turbine engine). The fire barrier is intended to prevent such a fire from spreading to other areas of the engine and/or to surrounding aircraft components.

The fire barrier includes openings to allow for the passage of various wires, lines, etc. that extend between the aircraft and the engine. The openings in the fire barrier are sealed to maintain the integrity of the fire barrier and prevent the spread of fire. However, sealing the openings is often difficult.

One existing seal includes a viscous sealant that is inserted into the opening. The sealant has viscosity to remain positioned in the opening and also provides for the wires, etc. to pass through the opening. It is often difficult to insert the sealant into the opening without forming gaps. The gaps would mitigate the effectiveness of the fire barrier and allow for fire to pass from the engine and into the wing. Further the sealant is difficult to test to determine that it effectively covers the opening.

Another issue is the opening in the fire barrier is often located in an area that is difficult to access. The size and configuration of the space between the wing and the engine is often small and/or compartmentalized making it difficult to access. It is often difficult to insert the sealant into these locations, insert the necessary tools to provide for sealing the opening, and/or visually seeing the opening to provide for working in the area. In some designs, access to the area immediately above the engine is not practical without removing the engine from the wing.

### SUMMARY

One aspect is directed to a terminal block configured to be mounted within an opening in a fire barrier. The terminal block comprises a central body sized to be positioned in the opening. A lower mount extends outward from a first side of the central body. An upper mount extends outward from a second side of the central body. Mounting surfaces are positioned on each of the lower mount and the upper mount. Electrical conductors extend between the mounting surfaces on the lower mount and the upper mount with the electrical conductors configured to enable an electrical connection between first and second sections of power feed lines.

In another aspect, the electrical conductors extend through an interior of the central body, the lower mount, and the upper mount.

In another aspect, a neck is positioned between the central body and the lower mount with the neck configured to receive a clamp to attach the terminal block to the fire barrier.

In another aspect, a support member extends outward from the second side of the central body and a moisture barrier comprising a plate is mounted to the support member and spaced above the upper mount and configured to direct moisture away from the upper mount.

In another aspect, the central body, the lower mount, and the upper mount are centered along a longitudinal center line.

In another aspect, the central body, the lower mount, and the upper mount are an integral unitary piece.

One aspect is directed to a terminal block for use with a wing assembly of an aircraft with the wing assembly comprising a strut box mounted to a wing, an engine mounted to the strut box, a fire barrier positioned between the strut box and the engine with the fire barrier comprising an opening, and a plurality of power feed lines each with a first section that extends from the engine and a second section that extends from an aircraft electrical unit. The terminal block comprises a central body sized to be positioned in the opening. A lower mount extends outward from a first side of the central body and is configured to be positioned in the engine on a first side of the fire barrier with the lower mount comprising a plurality of first mounting surfaces to connect to the first sections of the power feed lines. An upper mount extends outward from a second side of the central body to be positioned in the strut box on a second side of the first barrier with the upper mount comprising second mounting surfaces to connect to the second sections of the power feed lines. Electrical conductors extend within the terminal block between the first mounting surfaces and the second mounting surfaces. The terminal block enables the power feed lines to transfer electrical energy from the engine, through the fire barrier, and to the aircraft electrical unit.

In another aspect, the mounting surfaces are flat and configured to receive connectors mounted on the first and second sections of the power feed lines.

In another aspect, the central body extends radially outward from a longitudinal center line farther than the lower mount and the upper mount with the central body sized to fill the opening in the fire barrier.

In another aspect, the central body, the lower mount, and the upper mount are centered along a longitudinal center line of the terminal block.

In another aspect, the electrical conductors extend through an interior of the central body, the lower mount, and the upper mount.

In another aspect, a plate extends over the upper mount and is configured to direct moisture away from the upper mount that moves downward along the power feed lines.

One aspect is directed to a method of sealing an opening in a fire barrier at a wing of an aircraft. The method comprises: inserting a terminal block through an upper opening in a strut box while upper sections of power feed lines are connected to the terminal block; feeding the upper sections of the power feed lines through the upper opening and thereby lowering the terminal block through an interior space of the strut box; mounting the terminal block in a lower opening in a fire barrier; and connecting lower sections of the power feed lines that extend from the terminal block to an engine.

In another aspect, the method further comprises positioning the terminal block in the fire barrier directly and vertically below the upper opening in the strut box.

In another aspect, the method further comprises connecting the lower sections of the power feed lines to the terminal block and to the engine after mounting the terminal block in the lower opening.

In another aspect, the method further comprises connecting the lower sections of the power feed lines to the terminal block prior to inserting the terminal block through the upper opening.

In another aspect, the method further comprises feeding the lower sections of the power feed lines through the interior space of the strut box and through the lower opening in the fire barrier.

In another aspect, the method further comprises sealing the lower opening in the fire barrier after mounting the terminal block in the lower opening.

In another aspect, the method further comprises connecting the upper sections of the power feed lines to an electric unit in the aircraft.

In another aspect, the method further comprises transferring power from the engine through the lower sections of the power feed line, through the terminal block, and through the upper sections of the power feed lines while the terminal block is mounted in the lower opening in the fire barrier.

One example is directed to a terminal block configured to be mounted within an opening in a fire barrier between an engine and a strut box of an aircraft. The device comprises a central body sized to be positioned in the opening; a lower mount that extends outward from a first side of the central body, the lower mount configured to be positioned in the engine; an upper mount that extends outward from a second side of the central body, the upper mount configured to be positioned in the strut box; and mounting surfaces positioned on each of the lower mount and the upper mount.

In another example, the central body comprises a circular sectional shape.

In another example, each of the lower mount and the upper mount comprises a polygonal sectional shape with the mounting surfaces positioned along flat sides.

In another example, electrical connections extend between pairs of the mounting surfaces on the lower mount and the upper mount.

In another example, a neck is positioned between the central body and the lower mount with the neck configured to receive a clamp to attach the terminal block to the fire barrier.

In another example, a support member extends above the upper mount and a moisture barrier is mounted to the support member and spaced above the upper mount with the moisture barrier configured to direct moisture laterally away from the upper mount.

In another example, the central body extends laterally outward from a center line of the device farther than the lower mount and the upper mount.

In another example, each of the central body, the lower mount, and the upper mount are centered along a center line of the device.

In another example, the central body, the lower mount, and the upper mount are an integral unitary piece.

One example is directed to a terminal block configured to be mounted within an opening in a fire barrier between an engine and a strut box of an aircraft. The device comprises a central body sized to be positioned in the opening. A lower mount extends outward from a first side of the central body with the lower mount comprising a plurality of flat mounting surfaces. An upper mount extends outward from a second side of the central body with the upper mount comprising a plurality of flat mounting surfaces.

In another example, the central body extends laterally outward from a center line of the device farther than the lower mount and the upper mount.

In another example, each of the central body, the lower mount, and the upper mount are centered along a center line of the device.

In another example, electrical connection lines extend between pairs of the flat mounting surfaces.

In another example, the electrical connection lines extend through the central body.

One example is directed to an aircraft comprising: a fuselage; an aircraft electrical system; a wing that extends outward from the fuselage; a strut box mounted to the wing; an engine mounted to the strut box; a fire barrier positioned between the strut box and the engine with the fire barrier comprising an opening; a terminal block mounted in the opening to maintain the integrity of the fire barrier with the terminal block comprising a lower mount that extends into the engine compartment and an upper mount that extends into the strut box; a plurality of power feed lines each comprising a first section that extends between the engine and the lower mount and a second section that extends between the upper mount and the electrical unit. Wherein the power feed lines are configured to transfer electrical energy from the engine, through the fire barrier, and to the aircraft electrical system.

In another example, the fire barrier comprises a lower side of the strut box.

In another example, the opening is a first opening and further comprising a second opening in an upper side of the strut box, wherein the first opening and the second opening are vertically aligned.

In another example, the power feed lines pass through both of the first opening and the second opening.

In another example, the fire barrier further comprises a wall of the engine compartment.

One example is directed to a method of sealing an opening in a fire barrier at a wing of an aircraft. The method comprises: inserting a terminal block into an upper opening in a strut box that supports an engine on the wing; lowering the terminal block through an interior space of the strut box and into a lower opening in the strut box; and mounting the terminal block in the lower opening and sealing the lower opening.

In another example, the method further comprises lowering the terminal block through the interior space with power feed lines that are attached to the terminal block.

In another example, the method further comprises connecting lower sections of power feed lines to the terminal block and the engine after mounting the terminal block in the lower opening.

In another example, the method further comprises positioning additional material over the lower opening and sealing the lower opening.

One example is directed to a method of sealing an opening in a fire barrier at a wing of an aircraft. The method comprises: inserting a terminal block through an upper opening in a strut box while upper sections of power feed lines are connected to the terminal block; feeding the upper sections of the power feed lines through the upper opening and thereby lowering the terminal block through an interior space of the strut box; mounting the terminal block in an opening in a fire barrier; and connecting lower sections of the power feed lines that extend from the terminal block to an engine.

In another example, the method further comprises connecting the lower sections of the power feed lines to the terminal block prior to inserting the terminal block through the upper opening.

In another example, the method further comprises feeding the lower sections of the power feed lines through the interior space of the strut box and through the opening in the fire barrier.

In another example, the method further comprises mounting the terminal block in the opening and sealing the fire barrier.

In another example, the method further comprises connecting the upper sections of the power feed lines to an electric unit in the aircraft.

In another example, the method further comprises transferring power from the engine through the lower sections of the power feed line, through the terminal block, and through the upper sections of the power feed line while the terminal block is mounted in the opening in the fire barrier.

In another example, the method further comprises directing moisture that runs along the upper feed lines away from the terminal block while the terminal block is mounted in the opening.

In another example, the method further comprises mounting another terminal block in the opening of the fire barrier.

One example is directed to a method of operating an aircraft. The method comprises: mounting a terminal block within an opening in a fire barrier; electrically connecting upper sections of power feed lines between the terminal block and an electrical system of the aircraft; electrically connecting lower sections of the power feed lines between the terminal block and the engine; transferring electric power through the power feed lines from the engine to the electrical system while the terminal block is mounted in the opening; and detaching the lower sections of the power feed lines from the terminal block and removing the engine from the wing.

In another example, the method further comprises maintaining the upper sections of the power feed lines connected to the terminal block while removing the engine from the wing.

In another example, the method further comprises mounting the terminal block in the opening in the fire barrier and sealing the opening.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is an isometric view of an aircraft that includes an engine mounted to a strut box of the wing.

FIG. 2 is a schematic diagram of a generator electrically connected to a aircraft electrical system.

FIG. 3 is a schematic side view of an engine mounted to a strut box along a bottom of a wing of an aircraft.

FIG. 4 is an upper isometric view of a terminal block with connectors attached to mounting surfaces.

FIG. 5 is a lower isometric view of the terminal block of FIG. 3.

FIG. 6 is a schematic section view of electric lines that extend through the terminal block and electrically connecting paired mounting surfaces.

FIG. 7 is an isometric view of a terminal block mounted in an opening in a fire barrier along a wing of an aircraft.

FIG. 8 is a flowchart diagram of a method of sealing an opening in a fire barrier at a wing of an aircraft.

FIG. 9 is a flowchart diagram of a method of mounting a terminal block within an opening in a fire barrier of an aircraft.

### DETAILED DESCRIPTION

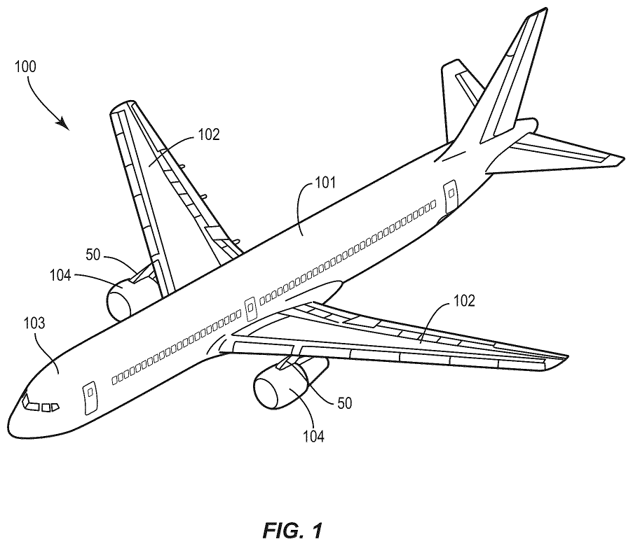

FIG. 1 illustrates an aircraft 100 that generally includes a fuselage 101 and wings 102. The interior of the fuselage 101 is configured to accommodate passengers and/or cargo. A flight deck 103 is positioned at the forward end of the fuselage 101 and includes controls to fly the aircraft 100. Each wing 102 includes an engine 104 mounted to a strut box 50. The number and positioning of the engines 104 on the wings 102 can vary. The aircraft 100 can include various types of engines 104 including but not limited to turbofan engines, turbo-prop engines, turbojet engines, and piston engines.

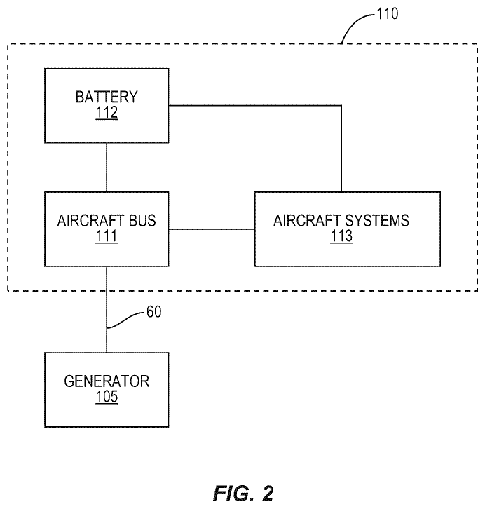

The engines 104 are equipped with a generator 105 that generates electrical energy. The generator 105 may be powered by, for example, a drive shaft (e.g., an auxiliary drive shaft) and/or bleed air from the gas turbine engine 104. As schematically illustrated in FIG. 2, the generator 105 is connected with a power feed line 60 to the aircraft electrical system 110. The aircraft electrical system 110 includes an aircraft bus 111 that facilitates use of the electrical energy generated by the generator 105 throughout the aircraft 100. The aircraft bus 111 is further electrically coupled to a battery 112 and one or more aircraft systems 113. The aircraft systems 113 may include one or more systems or components in the aircraft 100 that utilize electrical power, such as but not limited to the flight control instruments, the flight control surface actuators, lights, communication equipment, screens or displays, electrical outlets, and landing gear actuators. In some examples, the aircraft bus 111 routes the electrical energy from the generator 105 to the battery 112 to store the electrical energy for later use (e.g., to be routed to the aircraft systems 113 by the battery 112). Additionally or alternatively, the electrical energy from the generator 105 is routed directly to the aircraft systems 113.

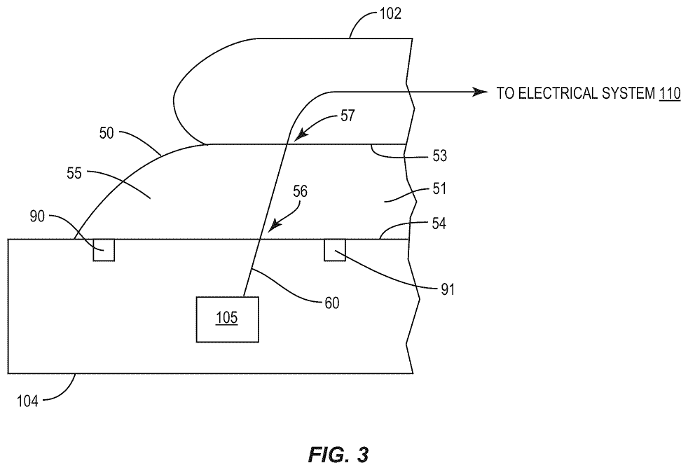

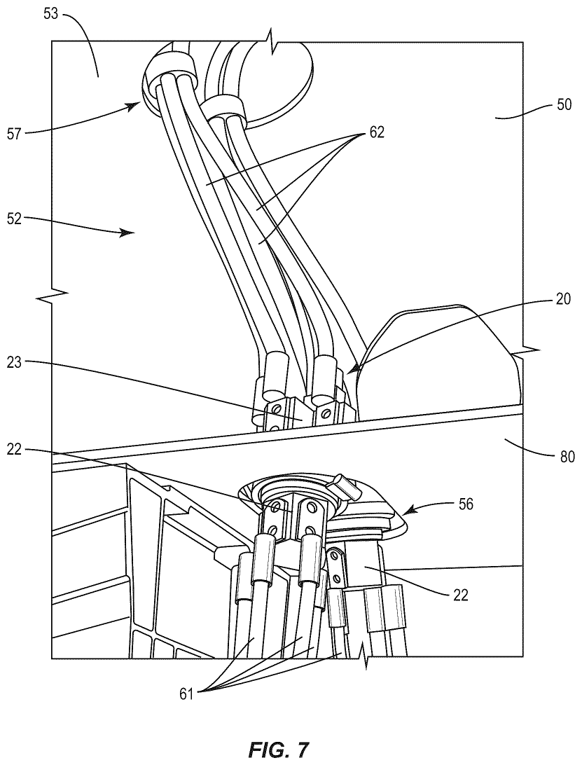

FIG. 3 illustrates a schematic diagram of an engine 104 mounted to a bottom of a strut box 50. The engine 104 is mounted to the strut box 50 by a forward mount 90 and an aft mount 91. The mounting positions the engine 104 against an underside of the strut box 50 at the wing 102. A fire barrier 80 (see FIG. 7) is positioned at the engine 104 to prevent a fire in the engine 104 from spreading to the strut box 50 and wing 102. In some examples, the fire barrier 80 is formed by one or more surfaces of the strut box 50, and a separate sheet that is installed on the bottom side 54 of the strut box 50 above the engine 104.

The strut box 50 is an elongated structural member that extends from the wing 102. The strut box 50 includes an outer member 51 that extends around and forms a hollow interior space 52. Various interior struts, ribs, and support members (not illustrated) are connected to the inner sides of the outer member 51 and extend within the interior space 52 (see FIG. 7) to provide strength to the strut box 50. The outer member 51 includes a top side 53 that faces away from the engine 104, a bottom side 54 that faces towards the engine 104, and lateral sides 55.

In some examples, the fire barrier 80 is formed by the bottom side 54 of the strut box 50. An opening 56 is formed in the bottom side 54 to provide for the power feed lines 60 to extend from a generator 105 to the aircraft electrical system 110. The opening 56 is required to be plugged to maintain the integrity of the fire barrier 80.

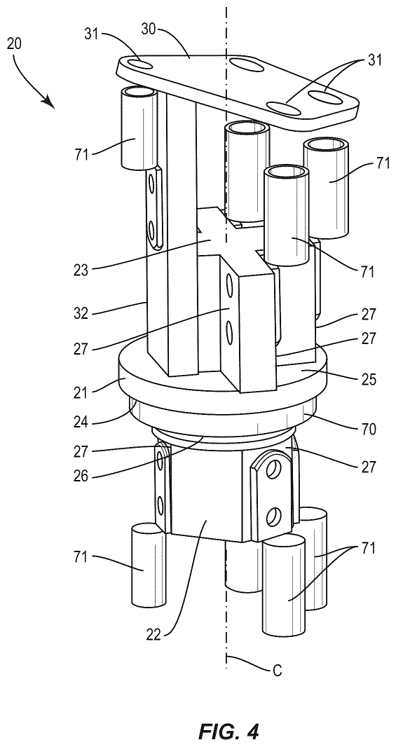

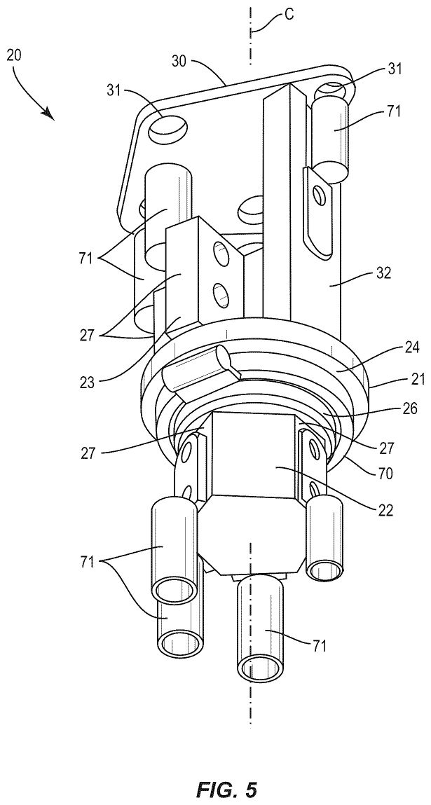

As illustrated in FIGS. 4 and 5, a terminal block 20 is sized to fit within the opening 56 in the fire barrier 80. The terminal block 20 is used to maintain the integrity of the fire barrier 80. The terminal block 20 also provides for disconnecting/connecting the power feed lines 60 during installation and removal of the engine 104 from the strut box 50 and the wing 102.

The terminal block 20 includes a central body 21 configured to be positioned in the opening 56. A lower mount 22 extends outward from a lower side 24 of the central body 21. The lower mount 22 is configured to connect to lower sections of the power feed lines 60 that extend to the engine 104. An upper mount 23 extends outward from an upper side 25 of the central body 21. The upper mount 23 is configured to connect to upper sections of the power feed lines 60 that extend to the aircraft electrical system 110.

A longitudinal center line C extends through the terminal block 20. In some examples, each of the central body 21, lower mount 22, and upper mount 23 are centered along the center line C. In other examples, one or more is offset from the center line C. In some examples, the terminal block 20 is a single unitary piece. In other examples, the central body 21, upper mount 23, and lower mount 22 are separate pieces that are connected together. In some examples, the central body 21 extends radially outward from the longitudinal center line C farther than either or both the lower mount 22 and the upper mount 23.

The central body 21 aligns with the opening 56 in the fire barrier 80 when mounted in position. In one example as illustrated in FIGS. 4 and 5, the central body 21 has a substantially circular shape. This shape conforms to the shape of the opening 56. The shape also facilitates insertion into and through the strut box 50 as will be explained in detail below. In other examples, the central body 21 includes different sectional shapes including but not limited to polygonal and oval. The central body 21 also includes a neck 26. The neck 26 includes a substantially circular shape and provides a structure for mounting the terminal block 20. In one example, the neck 26 provides for engagement with a clamp 70 to mount the terminal block 20 in the opening 56. When mounted, the central body 21 is aligned in the opening 56 and the neck 26 is positioned below the opening 56 (i.e., towards the engine 104).

The lower mount 22 provides for mounting the lower sections of the power feed lines 60. The lower mount 22 includes mounting surfaces 27 configured to mount connectors 71 that are engaged with the lower sections of the power feed lines 60. The upper mount 23 extends from the upper side 25 of the central body 21 and includes mounting surfaces 27 configured to connect with the upper sections of the power feed lines 60. In some examples, the mounting surfaces 27 are substantially flat to facilitate engagement with the connectors 71 and provide for an electrical connection. Other examples of the mounting surfaces 27 include different configurations. In one example as illustrated in FIGS. 4 and 5, the lower mount 22 has a polygonal shape and the upper mount 23 includes a cross-shape that each include flat sides forming the mounting surfaces 27 and provides physical separation of connectors 71 to reduce the risk of arcing. In other examples, the lower and upper mount 22, 23 include the same configuration.

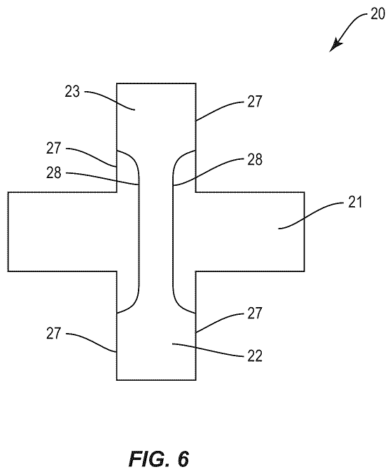

The terminal block 20 provides an electrical connection between the lower sections and upper section of the power feed lines 60. FIG. 6 schematically illustrates a terminal block 20. Electrical conductors 28 extend through the interior of the terminal block 20 between corresponding mounting surfaces 27 on the lower mounts 22 and upper mounts 23. The electrical conductors 28 provide for an electrical connection between the corresponding lower and upper sections of the power feed lines 60 when connected to the terminal block 20. In some examples, the terminal block 20 includes a non-conductive exterior. In some examples, the terminal block 20 is constructed from a non-conductive material with the electrical conductors 28 extending through the interior. Further, the construction of the terminal block 20 provides for maintaining the integrity of the fire barrier 80. The terminal block 20 can be constructed from a variety of materials including but not limited to heat resistant plastic or fiberglass or phenolic.

In some examples, a moisture barrier 30 is a plate mounted to the terminal block 20. The moisture barrier 30 is positioned vertically above the upper mount 23 and directs moisture that collects along the upper sections of the power feed lines 60 away from above the terminal block 20. The moisture barrier 30 is mounted on a support member 32 to extend over the upper mount 23. The moisture barrier 30 includes openings 31 sized and positioned to receive the upper sections of the power feed lines 60. Moisture that accumulates along the upper sections form as drops that can move along the upper sections. The drops contact against the moisture barrier 30 and are directed away from the terminal block 20. In some examples, the moisture barrier 30 is mounted at a tilted angle to direct the moisture to one side where it drips off the edge and away from the terminal block 20. Moisture barrier 30 may be made of silicone or another flexible material to provide tight contact with power feed lines 60.

FIG. 7 illustrates a pair of terminal blocks 20 mounted in an opening 56 in the fire barrier 80. Each terminal block 20 is positioned with the central body 21 aligned in the opening 56. In some examples, the opening 56 has a formed closure plate (not illustrated) with two openings of the size and orientation to tightly fit the central body 21. Clamps 70 (see FIGS. 4, 5) secure the position. In some examples, the central bodies 21 are shaped and sized to completely fill the opening 56. In some examples, additional materials such as but not limited to sealant, metal plates, and insulation are positioned at the opening 56 to fill a remainder.

FIG. 7 illustrates an example in which multiple terminal blocks 20 are mounted at the opening 56. In other examples, the opening 56 is sized for a single terminal block 20. In other examples, three or more terminal blocks 20 are mounted at the opening 56.

With the central body 21 positioned in the opening 56, the lower mount 22 extends downward and into the compartment of the engine 104. The mounting surfaces 27 are connected to connectors 71 mounted at the ends of the lower sections 61 of the power feed lines 60 that extend from the generator. The upper mounts 23 extend upward into the interior space 52 of the strut box 50. The mounting surfaces 27 are engaged with connectors 71 on the ends of the upper sections 62.

To facilitate insertion of the terminal block 20 into the opening 56 of the fire barrier 80, a second opening 57 is positioned in the top side 53 of the strut box 50. In some examples, the second opening 57 is vertically aligned over the opening 56. During use, the terminal block 20 is inserted through the second opening 57 and into the interior space 52. The upper sections 62 of the power feed lines 60 are connected to the terminal block 20 and manipulated to lower the terminal block 20 through the interior space 52 and into the opening 56. Because the second opening 57 is vertically aligned over the opening 56, the terminal block 20 can be lowered via gravity through the interior space 52 and into the opening 56.

In some examples, the lower sections 61 of the power feed lines 60 are connected to the terminal block 20 prior to insertion into the strut box 50. The lower sections 61 are lowered through the interior space 52 with the terminal block 20. Gravity causes the lower sections 61 to extend vertically downward from the terminal block 20 as the terminal block 20 is being lowered through the interior space 52. The exposed ends of the lower sections 61 are aligned with and lowered through the opening 56 followed by the remainder of the lower sections 61 and then the lower mount 22. In other examples, the lower sections 61 are not initially connected to the terminal block 20. In these examples, the terminal block 20 is inserted through the second opening 57 and lowered through the interior space 52. The terminal block 20 is positioned at the opening 56 at which time the lower sections 61 are mounted to the lower mount 22. In some examples, the power feed lines 60 are fed through the strut box 50 without requiring a technician to reach into the interior space 52.

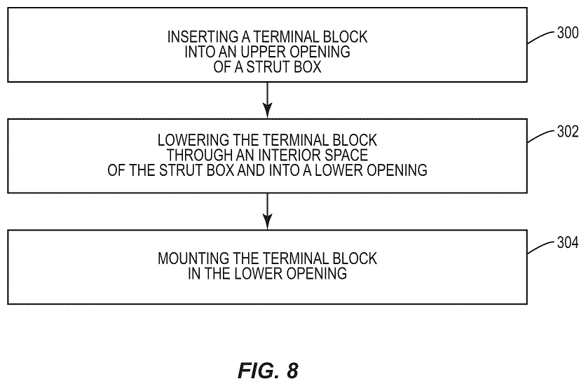

FIG. 8 illustrates a method of sealing an opening 56 in a fire barrier 80 at a wing 102 of an aircraft 100. The method includes inserting a terminal block 20 into an upper opening 57 in a strut box 50 that supports an engine 104 on the wing 102 (block 300). The terminal block 20 is lowered through an interior space 52 of the strut box 50 and into the opening 56 in the strut box 50 (block 302). The terminal block 20 is mounted in the lower opening 56 to seal the lower opening 56 (block 304).

In addition to plugging the opening 56 in the fire barrier 80, the terminal block 20 also facilitates removal of the engine 104 from the wing 102. During removal, the lower sections 61 of the power feed lines 60 are detached from the lower mount 22. The engine 104 can then be removed from the wing 102. Similarly, during attachment, the terminal block 20 is mounted in the opening 56 with the upper sections 62 attached to the upper mount 23. The engine 104 is positioned at the wing 102 and the lower sections 61 are connected to the lower mount 22.

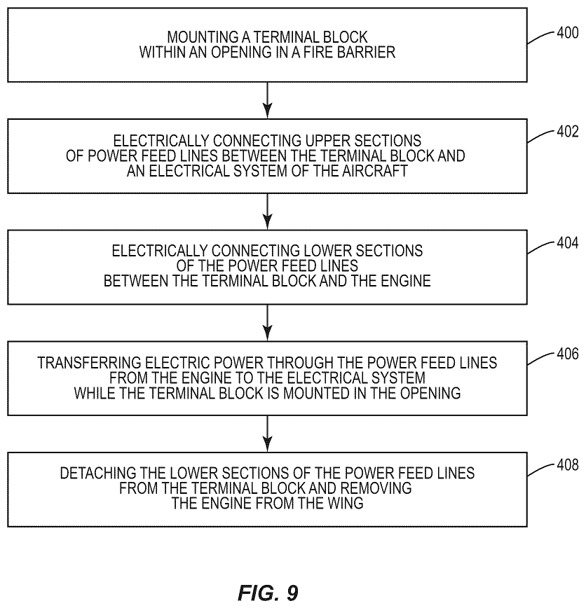

FIG. 9 illustrates a method that includes mounting a terminal block 20 within an opening 56 in a fire barrier 80 (block 400). The method includes electrically connecting upper sections 62 of power feed lines between the terminal block 20 and an electrical system 110 of the aircraft (block 402). The method includes electrically connecting lower sections 61 of the power feed lines between the terminal block 20 and the engine 104 (block 404). The method includes transferring electric power through the power feed lines 60 from the engine 104 to the electrical system 110 while the terminal block 20 is mounted in the opening 56 (block 406). The method includes at some point thereafter, detaching the lower sections 61 of the power feed lines 60 from the terminal block 20 and removing the engine 104 from the wing 102 (block 408).

In some examples, the upper sections 62 of the power feed lines 60 include another electrical disconnect at the interface of the strut box 50 and the wing wiring which connects to the electrical system 110 of the aircraft 100.

The features, functions and advantages that have been discussed can be achieved independently in various aspects or may be combined in yet other aspects, further details of which can be seen with reference to the following description and the drawings.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A terminal block configured to be mounted within an opening in a fire barrier, the terminal block comprising:
a central body sized to be positioned in the opening;
a lower mount that extends outward from a first side of the central body;
an upper mount that extends outward from a second side of the central body;
mounting surfaces positioned on each of the lower mount and the upper mount; and
electrical conductors that extend between the mounting surfaces on the lower mount and the upper mount, the electrical conductors configured to enable an electrical connection between first and second sections of power feed lines.

2. The terminal block of claim 1, wherein the electrical conductors extend through an interior of the central body, the lower mount, and the upper mount.

3. The terminal block of claim 1, further comprising a neck positioned between the central body and the lower mount, the neck is configured to receive a clamp to attach the terminal block to the fire barrier.

4. The terminal block of claim 1, further comprising:
a support member that extends outward from the second side of the central body; and
a moisture barrier comprising a plate mounted to the support member and spaced above the upper mount with the moisture barrier configured to direct moisture away from the upper mount.

5. The terminal block of claim 1, wherein the central body, the lower mount, and the upper mount are centered along a longitudinal center line.

6. The terminal block of claim 1, wherein the central body, the lower mount, and the upper mount are an integral unitary piece.

7. A terminal block for use with a wing assembly of an aircraft with the wing assembly comprising a strut box mounted to a wing, an engine mounted to the strut box, a fire barrier positioned between the strut box and the engine with the fire barrier comprising an opening, and a plurality of power feed lines each with a first section that extends from the engine and a second section that extends from an aircraft electrical unit, the terminal block comprising:
a central body sized to be positioned in the opening;
a lower mount that extends outward from a first side of the central body and configured to be positioned in the engine on a first side of the fire barrier, the lower mount comprising a plurality of first mounting surfaces to connect to the first sections of the power feed lines;
an upper mount extends outward from a second side of the central body to be positioned in the strut box on a second side of the first barrier, the upper mount comprising second mounting surfaces to connect to the second sections of the power feed lines;
electrical conductors that extend within the terminal block between the first mounting surfaces and the second mounting surfaces; and
wherein the terminal block enables the power feed lines to transfer electrical energy from the engine, through the fire barrier, and to the aircraft electrical unit.

8. The terminal block of claim 7, wherein the mounting surfaces are flat and configured to receive connectors mounted on the first and second sections of the power feed lines.

9. The terminal block of claim 7, wherein the central body extends radially outward from a longitudinal center line farther than the lower mount and the upper mount with the central body sized to fill the opening in the fire barrier.

10. The terminal block of claim 7, wherein the central body, the lower mount, and the upper mount are centered along a longitudinal center line of the terminal block.

11. The terminal block of claim 7, wherein the electrical conductors extend through an interior of the central body, the lower mount, and the upper mount.

12. The terminal block of claim 7, further comprising a plate that extends over the upper mount and is configured to direct moisture away from the upper mount that moves downward along the power feed lines.

13. A method of sealing an opening in a fire barrier at a wing of an aircraft, the method comprising:
inserting a terminal block through an upper opening in a strut box while upper sections of power feed lines are connected to the terminal block;
feeding the upper sections of the power feed lines through the upper opening and thereby lowering the terminal block through an interior space of the strut box;
mounting the terminal block in a lower opening in a fire barrier; and
connecting lower sections of the power feed lines that extend from the terminal block to an engine.

14. The method of claim 13, further comprising positioning the terminal block in the fire barrier directly and vertically below the upper opening in the strut box.

15. The method of claim 13, further comprising connecting the lower sections of the power feed lines to the terminal block and to the engine after mounting the terminal block in the lower opening.

16. The method of claim 13, further comprising connecting the lower sections of the power feed lines to the terminal block prior to inserting the terminal block through the upper opening.

17. The method of claim 13, further comprising feeding the lower sections of the power feed lines through the interior space of the strut box and through the lower opening in the fire barrier.

18. The method of claim 13, further comprising sealing the lower opening in the fire barrier after mounting the terminal block in the lower opening.

19. The method of claim 13, further comprising connecting the upper sections of the power feed lines to an electric unit in the aircraft.

20. The method of claim 13, further comprising transferring power from the engine through the lower sections of the power feed line, through the terminal block, and through the upper sections of the power feed lines while the terminal block is mounted in the lower opening in the fire barrier.
